(19) United States
(12) Patent Application Publication
(10) Pub. No.: US 2006/0048171 A1
(43) Pub. Date: Mar. 2, 2006

(54) Optical disc drive having an airflow guiding means

(76) Inventors: Chi-Cheng Lin, Taoyuan City (TW); Yi-Ling Lee, Taoyuan City (TW); Chih-Wei Tsao, Bade City (TW)

Correspondence Address: RABIN & Berdo, PC, 1101 14TH STREET, NW, SUITE 500, WASHINGTON, DC, 20005, US

(21) Appl. No.: 11/208,580

(22) Filed: Aug. 23, 2005

(30) Foreign Application Priority Data
Sep. 2, 2004 (TW) 93126585

(51) Int. Cl. G11B 33/14

(52) U.S. Cl. 720/648

(57) ABSTRACT

An optical disc drive comprising a chassis, a tray, an optical pickup, a housing and an airflow guiding means is provided. The tray is movably disposed on the chassis, for carrying a disc into and out of the optical disc drive. The optical pickup reads data on the disc covering parts of the aperture through the aperture. The housing covers the chassis. The airflow guiding means has several passages. The airflow guiding means is disposed in the optical disc drive and relatively to the aperture of the tray, for diverting airflow around the rotating disc.

This application claims the benefit of Taiwan application Serial No. 093126585, filed Sep. 2, 2004, the subject matter of which is incorporated herein by reference.

### BACKGROUND OF THE INVENTION

1. Field of the Invention

The invention relates in general to an optical disc drive, and more particularly to an optical disc drive having an airflow guiding means.

2. Description of the Related Art

Recently, because of the popularity of the multi-media disc, the optical disc drive has been a necessary product for work and entertainment. To satisfy the demands of the consumers, the optical disc drives with faster reading and writing speed are released by the industries.

However, the slight swaying of optical disc affects the reading and writing qualities seriously when disc rotates at a high speed. Although there are methods for solving the swaying of the optical disc at a low rotating speed, there is no solution for the problems of swaying of the optical disc at a high rotating speed, especially at the rotating speed between 154 Hz and 156 Hz. Therefore, how to reduce the swaying problems in optical disc and increase the reading and writing qualities of the high rotating speed optical disc drive are important issues at the present time.

### SUMMARY OF THE INVENTION

It is therefore an object of the invention to provide an optical disc drive having an airflow guiding means. The airflow guiding means is designed for the swaying mode of the optical disc at a high rotating speed, having the functions of guiding and modulating the airflow, and further solving the swaying problems of the optical disc at a high rotating speed.

The invention achieves the object by providing an optical disc drive comprising a chassis, a tray, an optical pickup, a housing, a first protrusion, a second protrusion and a third protrusion. The tray has an aperture and is movably disposed on the chassis, for carrying a disc into and out of the optical disc drive. The optical pickup reads data on the disc covering parts of the aperture through the aperture. The housing covers the chassis. The first protrusion is disposed in the optical disc drive and relatively to the aperture of the tray. The first protrusion is adjacent to an outer edge of the disc. The second protrusion is disposed in the optical disc drive and relatively to the aperture. The second protrusion is adjacent to the first protrusion, so that a first passage is formed separating the first protrusion from the second protrusions. The third protrusion is disposed in the optical disc drive and relatively to the aperture. The third protrusion faces the first passage, so that a second passage is formed separating the first protrusion and the second protrusion from the third protrusion.

The invention achieves the object by providing another optical disc drive comprising a chassis, a tray, an optical pickup, a housing and an airflow guiding means. The tray has an aperture and is movably disposed on the chassis, for carrying a disc into and out of the optical disc drive. The optical pickup reads data on the disc covering parts of the aperture through the aperture. The housing covers the chassis. The airflow guiding means having several passages is disposed in the optical disc drive and relatively to the aperture of the tray, for diverting airflow around the rotating disc.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an exploded view of an optical disc drive according to a first embodiment of the invention.

FIG. 2 is a perspective view of the optical disc drive according to the first embodiment of the invention.

FIG. 3 is a top view of the optical disc drive according to the first embodiment of the invention.

FIG. 3a is a cross-sectional view of the first embodiment of the invention taken along line 3A-3A′ and viewing from the arrowhead direction.

FIG. 4 illustrates the optical disc drive according to the first embodiment of the invention with the airflow flowing directions.

FIG. 5 is a top view of the optical disc drive according to the second embodiment of the invention.

FIG. 5A is a cross-sectional view of the second embodiment of the invention taken along line 5A-5A′ and viewing from the arrowhead direction.

FIG. 6 is a top view of the optical disc drive according to the third embodiment of the invention.

FIG. 6A is a cross-sectional view of the third embodiment of the invention taken along line 6A-6A′ and viewing from the arrowhead direction.

FIG. 7 is a top view of the optical disc drive according to the fourth embodiment of the invention.

FIG. 7A is a cross-sectional view of the fourth embodiment of the invention taken along line 7A-7A′ and viewing from the arrowhead direction.

FIG. 8 is a top view of the optical disc drive according to the fifth embodiment of the invention.

FIG. 8A is a cross-sectional view of the fifth embodiment of the invention taken along line 8A-8A′ and viewing from the arrowhead direction.

### DETAILED DESCRIPTION OF THE INVENTION

First Embodiment

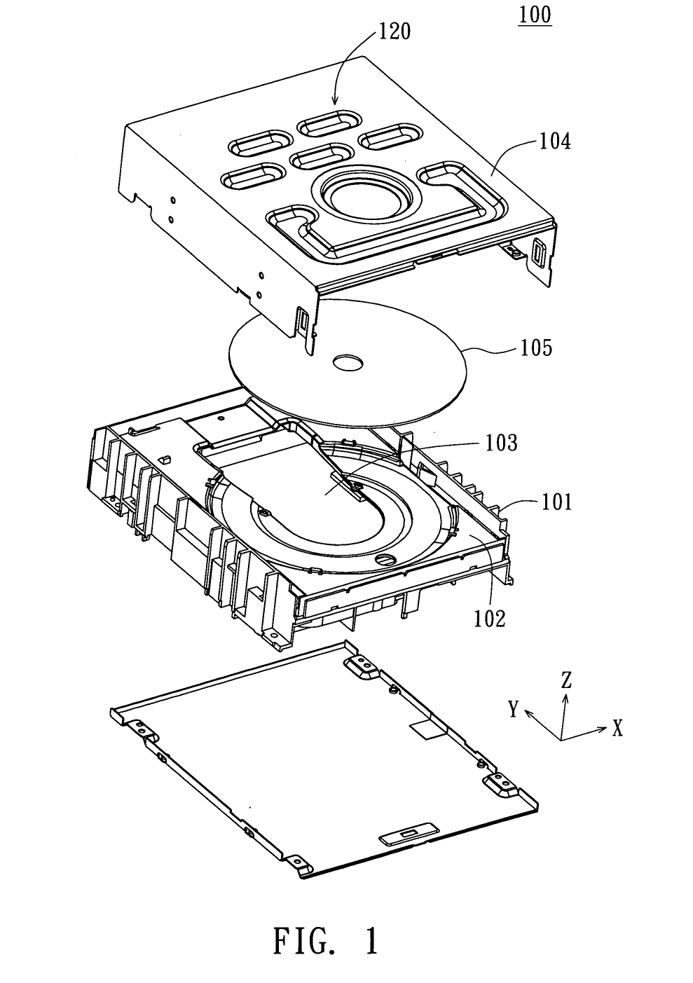

Please referring to FIG. 1, an exploded view of an optical disc drive according to a first embodiment of the invention is illustrated. The optical disc drive 100 comprises a chassis 101, a tray 102, a housing 104 and an airflow guiding means 120. The tray 102 has an aperture 103. The tray 102 is movably disposed on the chassis 101, for carrying a disc 105 into and out of the optical disc drive 100. An optical pickup (not shown in FIG. 1) reads data on the disc 105 through the aperture 103. The disc 105 covers parts of the aperture 103. The housing 104 covers the chassis 101. The airflow guiding means 120 has several passages. The airflow guiding means 120 is disposed in the optical disc drive 100 and relatively to the aperture 103 of the tray 102, for diverting the airflow around the rotating disc 105.

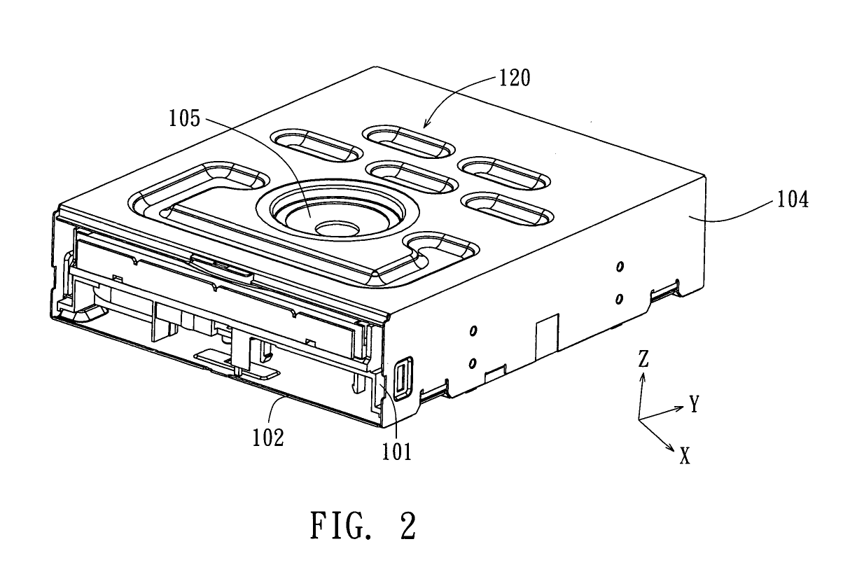

Please referring to FIG. 2, a perspective view of the optical disc drive according to the first embodiment of the invention is illustrated. In the optical disc drive 100, the airflow guiding means 120 is disposed between the disc 105 and the housing 104 along the z-axis, for dividing the space between the disc 105 and the housing 104 into many passages, and for diverting the airflow, keeping the air pressure stable, and avoiding the disc 105 from swaying.

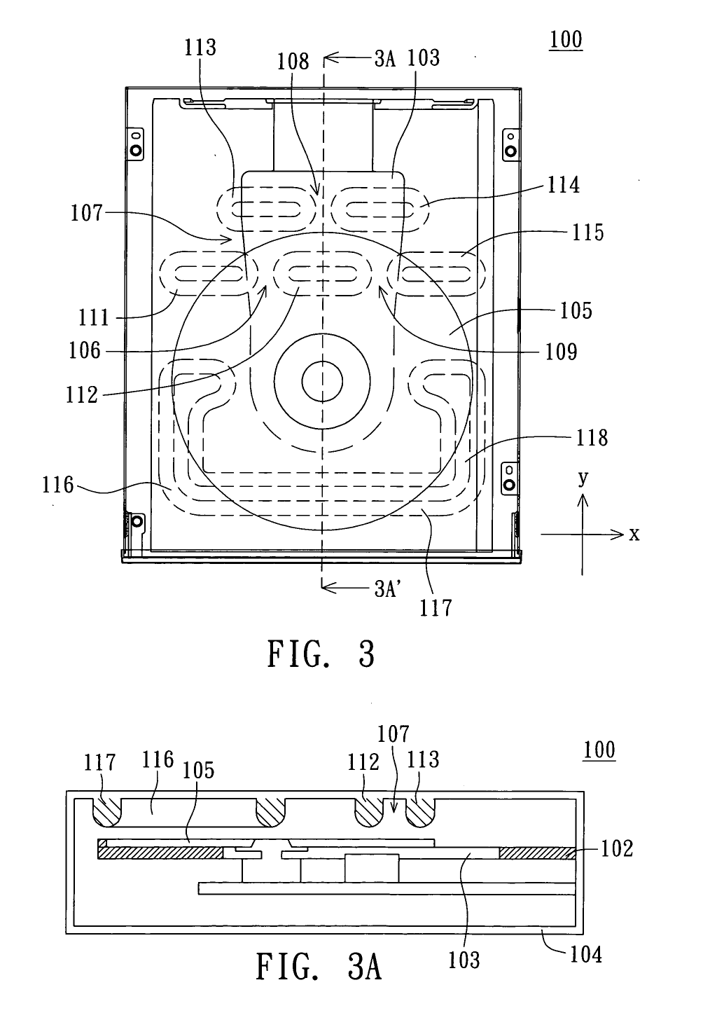

Please referring to FIG. 3, a top view of the optical disc drive according to the first embodiment of the invention is illustrated. The airflow guiding means comprises a first protrusion 111, a second protrusion 112, a third protrusion 113, a first passage 106 and a second passage 107. The first protrusion 111 is disposed in the optical disc drive 100 and relatively to the aperture 103 of the tray. The first protrusion 111 is adjacent to an outer edge of the disc 105. The second protrusion 112 is disposed in the optical disc drive 100 and relatively to the aperture 103. The second protrusion 112 is adjacent to the first protrusion 111, so that the first passage 106 is formed separating the first protrusion 111 from the second protrusion 112. The third protrusion 113 is disposed in the optical disc drive 100 and relatively to the aperture 103. The third protrusion 113 faces the first passage 106 and the second passage 107 is formed separating the first protrusion 111 and the second protrusion 112 from the third protrusion 113. The first passage 106 is disposed along the first direction (−y axis) and relatively to the aperture 103. The second passage 107 is disposed along the second direction (+x axis) and relatively to the aperture 103. The second passage 107 connects with the first passage 106.

In the optical disc drive 100, the tray 102 moves along the first direction (−y axis). The first protrusion 111 and the second protrusion 112 are disposed beside each other along the second direction (+x axis). An angle, such as 900, is made between the first direction and second direction. For example, the first protrusion 111, the second protrusion 112 and the third protrusion 113 are protruding strips extending along the second direction (+x axis), arranging in a triangular form. The first protrusion 111 and the second protrusion 112 are arranged in a row, and the third protrusion 113 is arranged alone in another row, so that the second passage 107 is formed between the two rows of the protrusions along the second direction (+x axis).

Furthermore, as shown in FIG. 3, the optical disc drive 100 further comprises a fourth protrusion 114, a fifth protrusion 115, a third passage 108 and a fourth passage 109. The fourth protrusion 114 is disposed in the optical disc drive 100 and relatively to the aperture 103. The fourth protrusion 114 is adjacent to the third protrusion 113 and the second protrusion 112. The third passage 108 is formed separating the third protrusion 113 from the fourth protrusion 114. The second passage 107 is formed separating the second protrusion 112 from the fourth protrusion 114. The fifth protrusion 115 is disposed in the optical disc drive 100 and relatively to the aperture 103. The fifth protrusion 115 is adjacent to the second protrusion 112 and the fourth protrusion 114, so that the fourth passage 109 is formed separating the second protrusion 112 from the fifth protrusion 115, and the second passage 107 is formed separating the fourth protrusion 114 from the fifth protrusion 115. In the optical disc drive 100, the first protrusion 111, the second protrusion 112 and the fifth protrusion 115 are disposed beside each other along the second direction (+x axis), and the third protrusion 113 and the fourth protrusion 114 are disposed beside each other along the second direction (+x axis). Moreover, the third passage 108 and the fourth passage 109 are along the first direction (−y axis), connecting with the second passage 107 respectively.

Furthermore, as shown in FIG. 3, the airflow guiding means further comprises a first protruding strip 116, a second protruding strip 117 and a third protruding strip 118, positioned in the optical disc drive 100 and respectively along a direction tangent to the disc 105 and the housing 104. The first protruding strip 116, the second protruding strip 117 and the third protruding strip 118 are disposed on a first inner side, a second inner side and a third inner side of the housing 104 respectively. A fourth inner side of the housing 104 is relative to the aperture 103 of the tray. The first protrusion 111, the second protrusion 112 and the third protrusion 113 are disposed relatively to the fourth inner side of the housing 104.

Please referring to FIG. 3A, a cross-sectional view of the first embodiment of the invention taken along line 3A-3A′ and viewing from the arrowhead direction is illustrated. In the optical disc drive 100, the first protrusion 111, the second protrusion 112 and the third protrusion 113 are disposed on the housing 104 inside the optical disc drive 100, dividing the space between the housing 104 and the disc 105 to form the passages.

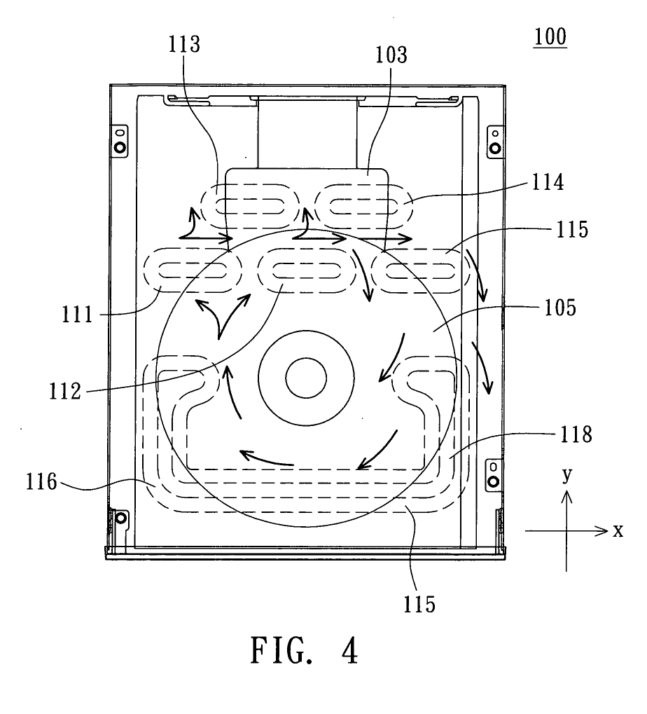

Please referring to FIG. 4, the optical disc drive according to the first embodiment of the invention with the airflow flowing directions is illustrated. The optical disc drive 100 comprises the airflow guiding means 120, dividing the space between the disc 105 and the housing. Especially the airflow guiding means relative to the aperture 103 forms many passages, providing channels for diverting and guiding the airflow. When the disc 105 rotates, the circulating airflow above the disc 105 flows into the passages. Through the passages connecting with each other, the airflow is dispersed or guided to modulate the pressure, for reducing the agitating of the disc 105 resulted from the air pressure. Therefore, even if the disc 105 rotates at a high rotating speed, such as the rotating speed over 150 Hz, the optical disc drive 100 having an airflow guiding means of this embodiment can divert the airflow to modulate air pressure, for controlling the swaying of the disc.

Second Embodiment

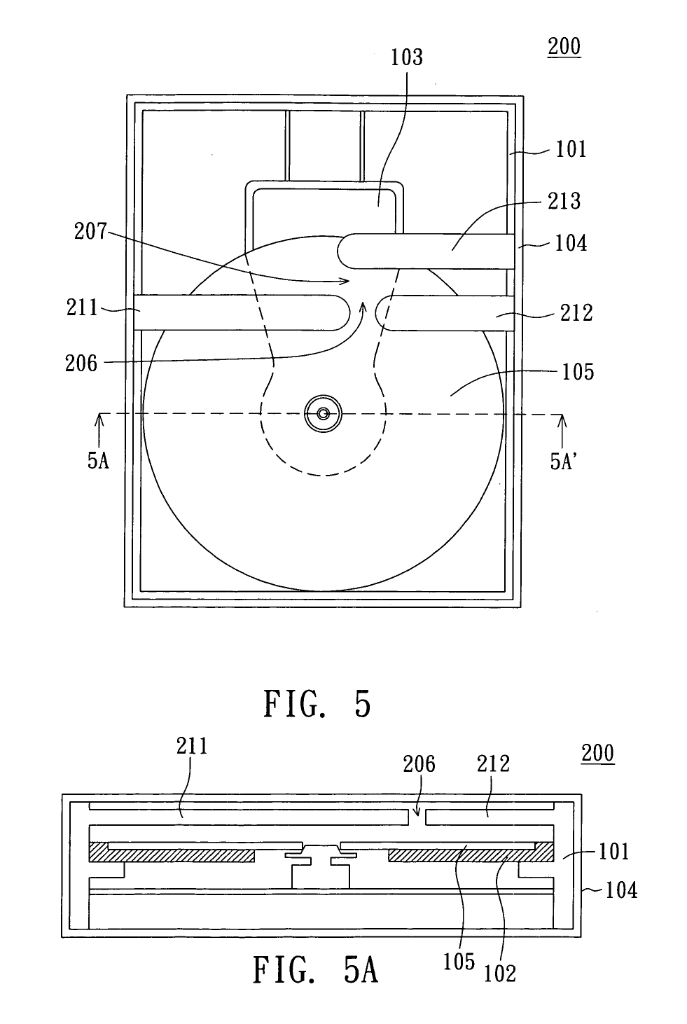

Please referring to FIG. 5, a top view of the optical disc drive according to the second embodiment of the invention is illustrated. The difference between the optical disc drive 200 of this embodiment and the optical disc drive 100 of the first embodiment is the forming position of the airflow guiding means. Other elements are all the same, and the same reference numbers are used, too. In the optical disc drive 200 of this embodiment of the invention, the first protrusion 211, the second protrusion 212 and the third protrusion 213 are disposed on the chassis 101 and extend from a side above the aperture 103. The first passage 206 and the second passage 207 are formed above the disc 105.

Please referring to FIG. 5A, a cross-sectional view of the second embodiment of the invention taken along line 5A-5A′ and viewing from the arrowhead direction is illustrated. In the optical disc drive 200, the first protrusion 211, the second protrusion 212 and the third protrusion (not shown in FIG. 5A) are formed above the aperture 103. For example, the first protrusion 211, the second protrusion 212 and the third protrusion 213 are formed above the aperture 103 and the disc 105, as shown in FIG. 5. Furthermore, protrusions with a thickness divide the space between the housing 104 and the disc 105 to form passages.

Third Embodiment

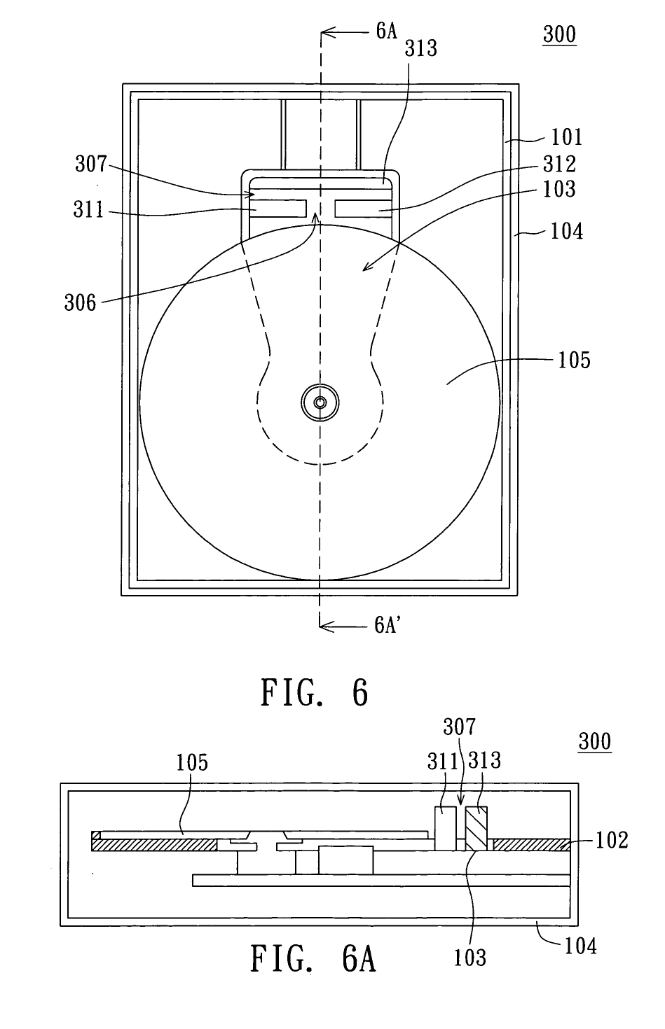

Please referring to FIG. 6, a top view of the optical disc drive according to the third embodiment of the invention is illustrated. The difference between the optical disc drive 300 of this embodiment and the optical disc drive 100 of the first embodiment is the forming position of the airflow guiding means. Other elements are all the same, and the same reference numbers are used, too. In the optical disc drive 300 of the embodiment, the first protrusion 311, the second protrusion 312 and the third protrusion 313 are disposed protruding from the aperture 103 of the tray. The first passage 306 and the second passage 307 are formed in the aperture 103.

Please referring to FIG. 6A, a cross-sectional view of the third embodiment of the invention taken along line 6A-6A′ and viewing from the arrowhead direction is illustrated. In the optical disc drive 300, the first protrusion 311, the second protrusion (not shown in FIG. 6A) and the third protrusion 313 are formed in the aperture 103 and protrude from a surface of the tray 102, dividing the space between the housing 104 and the tray 102 to form passages.

Fourth Embodiment

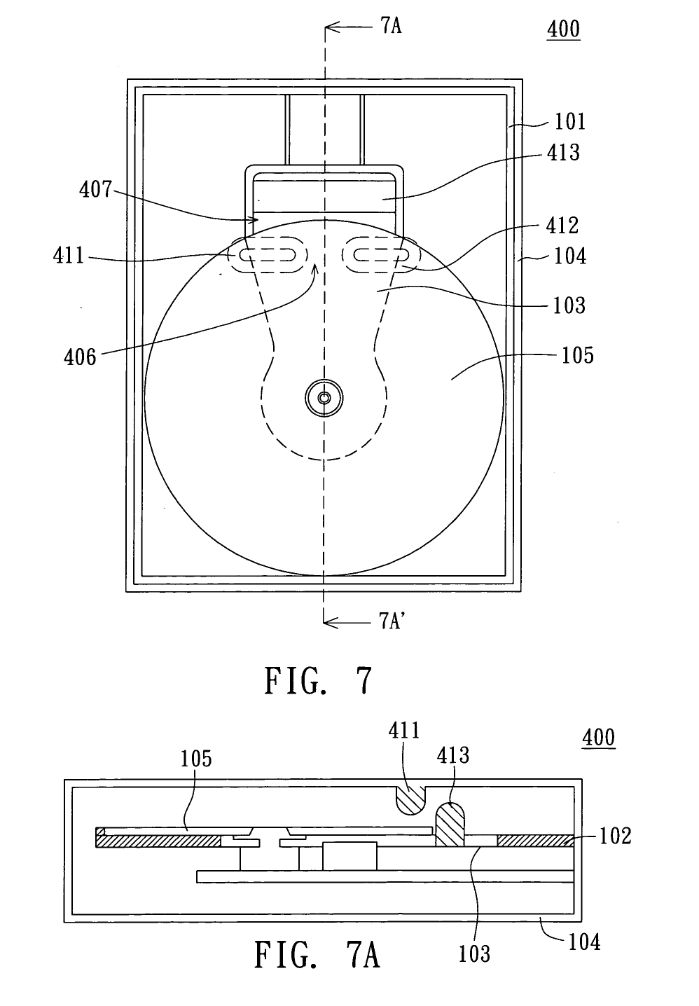

Please referring to FIG. 7, a top view of the optical disc drive according to the fourth embodiment of the invention is illustrated. The difference between the optical disc drive 400 of this embodiment and the optical disc drive 100 of the first embodiment is the forming position of the airflow guiding means. Other elements are all the same, and the same reference numbers are used, too. In the optical disc drive 400 of this embodiment, the first protrusion 411 and the second protrusion 412 are disposed on the housing 104. The third protrusion 413 is disposed on the tray 102. The first passage 406 is formed above the disc 105. The second passage 407 is formed in the boundary of the aperture 103 and the disc 105.

Please referring to FIG. 7A, a cross-sectional view of the fourth embodiment of the invention taken along line 7A-7A′ and viewing from the arrowhead direction is illustrated. In the optical disc drive 400, the first protrusion 411 and the second protrusion (not shown in FIG. 7A) are formed above the aperture 103, and the third protrusion 413 protrudes from a surface of the tray 102, dividing the space between the housing 104 and the tray 102 to form passages.

Fifth Embodiment

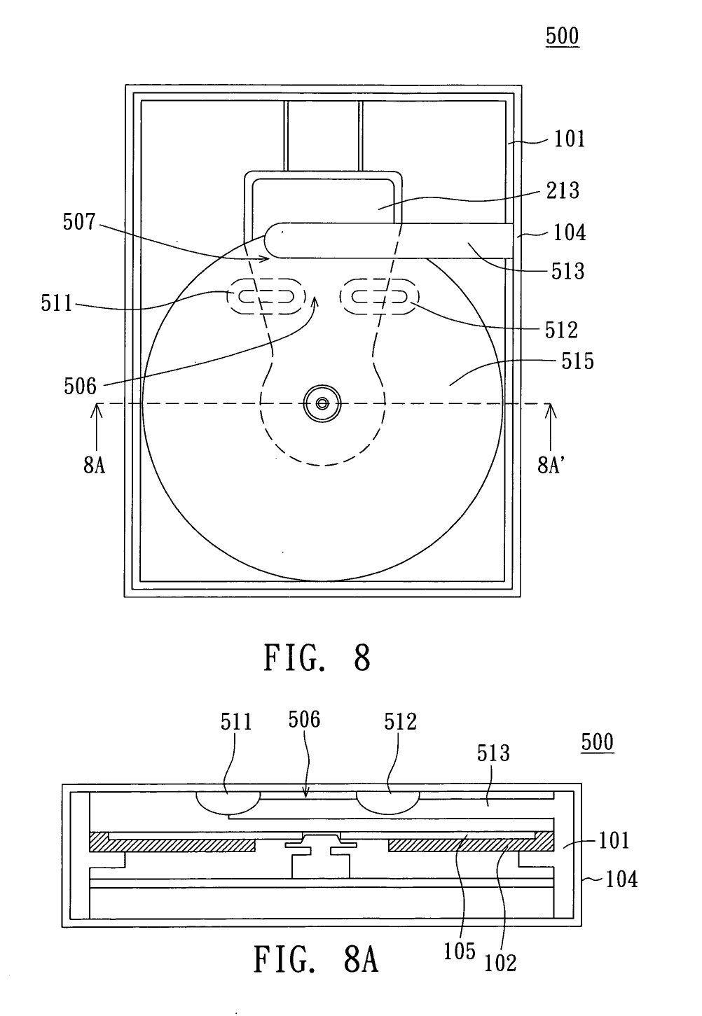

Please referring to FIG. 8, a top view of the optical disc drive according to the fifth embodiment of the invention is illustrated. The difference between the optical disc drive 500 of this embodiment and the optical disc drive 100 of the first embodiment is the forming position of the airflow guiding means. Other elements are all the same, and the same reference numbers are used, too. In the optical disc drive 500 of this embodiment, the first protrusion 511 and the second protrusion 512 are disposed on the housing 104. The third protrusion 513 is disposed on the chassis 101. The first passage 506 and the second passage 507 are formed above the disc 105.

Please referring to FIG. 8A, a cross-sectional view of the fifth embodiment of the invention along 8A-8A′ and viewing from the arrowhead direction is illustrated. In the optical disc drive 500, the first protrusion 511, the second protrusion (not shown in FIG. 8A) and the third protrusion 513 are formed above the disc 105, dividing the space between the housing 104 and the disc 105 to form passages.

Although the aforementioned embodiments are illustrated as examples of the invention, the invention is not limited thereto. It is apparent to those skilled in the art that the airflow guiding means of the invention can be disposed on the housing, the tray, the chassis and the combination thereof. For example, at least one of the first protrusion, the second protrusion and the third protrusion is disposed on the housing; at least one of the first protrusion, the second protrusion and the third protrusion is disposed on the chassis and extends above the aperture; at least one of the first protrusion, the second protrusion and the third protrusion is formed in one piece with the tray.

In the aforementioned embodiments of the invention, the cost of the optical disc drive having an airflow guiding means is inexpensive and the agitating of the disc is slight. First, the airflow guiding means of the aforementioned optical disc drive forms several passages. The airflow guiding means acts as a modulating valve, diverting the air pressure and avoiding the disc from swaying resulted from the irregular agitating of the airflow. Moreover, the airflow guiding means is designed particularly for the swaying mode of the disc at high rotating speed. The airflow guiding means can solve the swaying problems of the disc, especially for the range of high rotating speed (154-156 Hz). Therefore, the problems unsolved for a long time can be solved. In the aspect of production cost, the airflow guiding means of the invention is formed on the tray or the chassis by a plastic mold, or even molded directly on the housing. The manufacture process is easy and the cost is inexpensive. As a whole, the aforementioned embodiments of the invention adopt the airflow passages artfully to reduce the swaying degree of the high rotating disc and solve the problems with an inexpensive means.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical disc drive comprising:
a chassis;
a tray, having an aperture and movably disposed on the chassis, for carrying a disc into or out of the optical disc drive;
an optical pickup for reading data on the disc covering parts of the aperture through the aperture;
a housing for covering the chassis;
a first protrusion, disposed in the optical disc drive and relatively to the aperture of the tray, wherein the first protrusion is adjacent to an outer edge of the disc;
a second protrusion, disposed in the optical disc drive and relatively to the aperture, wherein the second protrusion is adjacent to the first protrusion, so that a first passage is formed separating the first protrusion from the second protrusion; and
a third protrusion, disposed in the optical disc drive and relatively to the aperture, wherein the third protrusion faces the first passage, so that a second passage is formed separating the first protrusion and the second protrusion from the third protrusion.

2. The optical disc drive as claimed in claim 1, wherein the tray moves along a first direction, the first protrusion and the second protrusion are disposed beside each other along a second direction, and an angle is made between the first direction and the second direction.

3. The optical disc drive as claimed in the claim 2, wherein the angle between the first direction and the second direction is substantially 90°.

4. The optical disc drive as claimed in claim 2, wherein the first passage is disposed along the first direction, the second passage is disposed along the second direction, and an angle is made between the first passage and the second passage.

5. The optical disc drive as claimed in claim 4, wherein the angle between the first passage and the second passage is substantially 90°.

6. The optical disc drive as claimed in claim 1, wherein at least one of the first protrusion, the second protrusion and the third protrusion is disposed on the housing.

7. The optical disc drive as claimed in claim 1, wherein at least one, of the first protrusion, the second protrusion and the third protrusion is disposed on the chassis and extends above the aperture.

8. The optical disc drive as claimed in claim 2, further comprising:
a fourth protrusion, disposed in the optical disc drive and relatively to the aperture, wherein the fourth protrusion is adjacent to the third protrusion and the second protrusion, so that a third passage is formed separating the third protrusion form the fourth protrusion, and the second passage is formed separating the second protrusion from the fourth protrusion; and
a fifth protrusion, disposed in the optical disc drive and relatively to the aperture, wherein the fifth protrusion is adjacent to the second protrusion and the fourth protrusion, so that a fourth passage is formed separating the second protrusion from the fifth protrusion, and the second passage is formed separating the fourth protrusion from the fifth protrusion.

9. The optical disc drive as claimed in claim 8, wherein the first protrusion, the second protrusion and the fifth protrusion are disposed beside each other along the second direction, and the third protrusion and the fourth protrusion are disposed beside each other along the second direction.

10. The optical disc drive as claimed in claim 8, wherein the third passage and the fourth passage are along the first direction and connect with the second passage respectively.

11. The optical disc drive as claimed in claim 1, further comprising a first protruding strip, a second protruding strip and a third protruding strip, positioned in the optical disc drive and disposed adjacent to a first inner side, a second inner side and a third inner side of the housing respectively, wherein a fourth inner side of the housing is relative to the aperture of the tray;
wherein the first protrusion, the second protrusion and the third protrusion are adjacent to the fourth inner side of the housing.

12. The optical disc drive as claimed in claim 11, wherein the first protruding strip, the second protruding strip and the third protruding strip are formed in one piece.

13. An optical disc drive comprising:
a chassis;
a tray, having a aperture and movably disposed on the chassis, for carrying a disc into and out of the optical disc drive;
an optical pickup, reading data on the disc covering parts of the aperture through the aperture;
a housing, covering the chassis; and
an airflow guiding means, having a plurality of passages and disposed in the optical disc drive and relatively to the aperture of the tray, for diverting airflow around the rotating disc.

14. The optical disc drive as claimed in claim 13, wherein the passages comprise:
a first passage, disposed along a first direction and relatively to the aperture; and
a second passage, disposed along a second direction and relatively to the aperture, wherein the second passage connects with the first passage, and an angle is made between the first direction and the second direction.

15. The optical disc drive as claimed in claim 13, wherein the airflow guiding means comprises:
a first protrusion, disposed in the optical disc drive and relatively to the aperture of the tray, wherein the first protrusion is adjacent to an outer edge of the disc;
a second protrusion, disposed in the optical disc drive and relatively to, the aperture, wherein the second protrusion is adjacent to the first protrusion, so that the first passage is formed separating the first protrusion from the second protrusion; and
a third protrusion, disposed in the optical disc drive and relatively to the aperture, wherein the third protrusion faces the first passage, so that the second passage is formed separating the third protrusion from the first protrusion and the second protrusion.

16. The optical disc drive as claimed in claim 13, wherein the tray moves along the first direction, and the first protrusion and the second protrusion are disposed beside each other along the second direction.

17. The optical disc drive as claimed in claim 15, wherein the airflow guiding means further comprises:
a fourth protrusion, disposed in the optical disc drive and relatively to the aperture, wherein the fourth protrusion is adjacent to the third protrusion, so that a third passage is formed separating the third protrusion from the fourth protrusion, and the second passage is formed separating the fourth protrusion from the second protrusion; and
a fifth protrusion, disposed in the optical disc drive and relatively to the aperture, wherein the fifth protrusion is adjacent to the second protrusion, so the a fourth passage is formed separating the fifth protrusion from the second protrusion, and the second passage is formed separating the fourth protrusion from the fifth protrusion.

18. The optical disc drive as claimed in claim 17, wherein the first protrusion, the second protrusion and the fifth protrusion are disposed beside each other along the second direction, and the third protrusion and the fourth protrusion are disposed beside each other along the second direction.

19. The optical disc drive as claimed in claim 17, wherein the third passage and the fourth passage are along the first direction and connect with the second passage respectively.

20. The optical disc drive as claimed in claim 13, wherein the airflow guiding means further comprises a first protruding strip, a second protruding strip and a third protruding strip, positioned in the optical disc drive, adjacent to a first inner side, a second inner side and a third inner side of the housing respectively, wherein a fourth inner side of the housing is relative to the aperture of the tray;
wherein the first protrusion, the second protrusion and the third protrusion are adjacent to the fourth inner side of the housing.
